(19) United States
(12) Patent Application Publication
(10) Pub. No.: US 2005/0080680 A1
(43) Pub. Date: Apr. 14, 2005

(54) RFID process control system for use in automation and inventory tracking applications

(76) Inventors: Kelson Elam, Heath, TX (US); William Anderson, Dallas, TX (US)

Correspondence Address: Navarro Law Office, P.C., P.O. Box 166851, Irving, TX, 75016, US

(21) Appl. No.: 10/771,770

(22) Filed: Feb. 2, 2004

Related U.S. Application Data
(60) Provisional application No. 60/444,026, filed on Jan. 31, 2003.

(51) Int. Cl. G06G 1/14

(52) U.S. Cl. 705/22; 705/28; 340/10.1

(57) ABSTRACT

A RFID process control system combines various components in a single enclosure for use in tracking RFID tagged inventory items. The invention provides a system that combines a RFID controller and reader, process software, a computer controlled switch, and power management subsystem into a single enclosure thereby facilitating RFID process control in connection with a wide array of inventory tracking applications.

### PRIOR PROVISIONAL APPLICATION

This application claims the benefit of filing and priority of provisional application Ser. No. 60/444,026, entitled “RFID PERIPHERAL MANAGEMENT SYSTEM FOR USE IN PROCESS AUTOMATION AND INVENTORY TRACKING APPLICATIONS” filed Jan. 31, 2003.

### TECHNICAL FIELD

The present invention relates to processes and systems for inventory tracking and process control. More specifically, the invention relates to a system that combines several integrated components for use in applications utilizing Radio Frequency Identification (RFID) to track inventory items. Still more particularly, the invention provides a system that combines a RFID reader, a PC board, a computer controlled switch, and flexible power management board all into one package thereby facilitating RFID process control in connection with a wide array of inventory tracking applications.

### BACKGROUND OF THE INVENTION

Radio frequency identification (RFID) first appeared in tracking and access applications during the 1980s. These wireless RFID systems allowed for non-contact reading and were effective in manufacturing and other hostile environments where bar code labels could not survive. Through the years, and because of its ability to track moving objects, RFID has established itself in several markets and applications including livestock identification and automated vehicle identification (AVI) systems.

While RFID has been around and used as a reliable means of tracking both static and moving inventory items, its use on a wide scale basis has been hampered by high cost and inefficient process control. Today most RFID applications involve only the collection of data as inventory items pass through one or more fixed reader stations. Such prior art process control solutions include the use of separate components in combination with an RFID-bases system. Typically in such applications a computer, such as a PC, is attached to a RFID reader which acts as a peripheral device to the PC. A separate computer controlled switch can be configured to control process peripherals, such as indicator lights and electronic message boards. In this way, software on the computer can be programmed to detect an event via the reader and cause the switch to reach a desired state. Process peripherals may be attached to the computer allowing the performance of a specified function via the attached process peripherals. Power to the system typically comprises a separate power source, such as a 12 Volt battery, solar panel, or other independent power means, configured to operate within the specific RFID environment in which the various components are situated.

The limitations of prior art RFID process control solutions are many and include their overall size and weight which prohibits their use and deployment in many applications. Moreover, prior art RFID process control systems lacked device and function integration requiring the use of multiple and disparate components and related interconnections. In addition, known prior art RFID process controllers employ a number of different power requirements and a number of different interfaces which lack integration and make deployment in a wide array of field applications difficult or impossible. For example, in an environment having multiple RFID stations, prior art RFID process control systems typically required the placement of separate components (PC, reader, power, software, wiring, etc . . . ) at each station with wiring of each component to other components to achieve integration. The architecture of coupling various components to one another and ensuring their interface to each other creates obstacles to flexible deployment, system maintenance and interoperability.

As such, there is a need for an integrated RFID process control system and method of achieving process control within an RFID tracking application. A system that reduces the size, weight and integration limitations of the known prior art would be useful in a wider range of inventory tracking applications and would provide numerous advantages.

### SUMMARY OF THE INVENTION

The present invention provides an integrated RFID process control system and method of using same that can be incorporated into a wide array of RFID inventory tracking applications to control the processing of inventory items passing through one or RFID stations. In essence, with the present invention a single enclosure is provided housing all of the various separate components including controller, RFID reader, circuit controlled switch, power management and interface. Process software is provided and stored within the enclosure such that a desired process can be controlled at the Point of Action (POA) eliminating the need for separate and independently controlled components. A flexible interface is provided conforming to multiple known industry standards thereby allowing quick deployment without special wiring.

According to one exemplary embodiment, disclosed is a radio frequency identification (RFID) process control system comprising an interface supporting communications with a plurality of industry standard compliant devices. A RFID controller for communicating RFID data over the interface, the RFID controller including at least one RFID reader for reading said RFID data from an RFID tagged item. Process control software is provided for detecting the occurrence of a specified event represented by the RFID data and at least one computer controlled switched operably coupled to the RFID controller. With this configuration, a specified RFID event can be determined from the RFID data received by the RFID controller via the interface as interpreted by the process control software and thereby cause the RFID controller to operate the computer controlled switch to control a desired process.

According to another exemplary embodiment, disclosed is a radio frequency Identification (RFID) process control system comprising an interface supporting communications with a plurality of industry standard compliant devices including at least one RFID tagged item. An RFID controller for communicating RFID data with the RFID tagged item over the interface is provided along with process control software for detecting the occurrence of a specified event represented by the RFID data. At least one computer controlled switched is operably coupled to the RFID controller and an enclosure housing the interface, RFID controller, process control software and computer controlled switch. With this configuration, a specified RFID event can be determined from the RFID data received by the RFID controller via the interface as interpreted by the process control software and thereby cause the RFID controller to operate the computer controlled switch to control a desired process.

A technical advantage of the invention is an open architecture which permits the simple integration of components which can be added or subtracted to suit many different types of RFID readers or different types of peripheral without having to build a custom solution every time.

Another technical advantage is flexible and integrated power management within a single enclosure allowing easy deployment. With the present invention, a single enclosure including computer, reader, switch and flexible power management system is installed near at or at the POA.

Still another advantage of the present invention is a centralized architecture that integrates the controller with the reader which allows interface with all RFID readers that may be used in a particular inventory tracking application as well as management control over the process peripherals via a computer controlled switch. Thus, when an event is detected at the data collection stage, a response can immediately be initiated from the POA.

Still another advantage of the present invention is a flexible communications interface which allows multiple methods of communication. The invention encompasses a single enclosure with a translation layer and various physical interfaces that will accommodate a wide range of readers such as a serial port, USB, Ethernet, wireless or other industry standard method. Thus, even though a serial reader is used, communications with the reader can be accomplished over internet or wireless LAN as the translation layer provides the data interface between user and reader.

Yet still another advantage is a flexible power management subsystem in the enclosure that can be operated using either AC current or DC current. In this regard, a battery charging circuit is provided that eliminates the need for an external UPS. The power management feature of the RFID process control system of the invention provide a way of regulating power to components operating at different voltages. This facilitates deployment since it eliminates the need to provide multiple sources of power.

These and other advantages of the present invention will be understood by those of ordinary skill in the art upon review of the following descriptions in connection with the attached drawings.

### BRIEF DESCRIPTIONS OF FIGURES ILLUSTRATING THE INVENTION

FIG. 1 is a block diagram of an RFID process control system adapted for use with an RFID inventory tracking system according to one embodiment of the invention;

FIGS. 2, 3, 4 and 5 illustrate the mechanical details of an enclosure suitable for use in an RFID system according to the invention;

FIG. 6 shows the flexible communications interface which supports multiple methods of communications with an RFID process control system according to the invention;

FIG. 7 illustrates further mechanical details of an enclosure suitable for use with an RFID process control system according to the invention; and

FIG. 8 is a process flow diagram of the method of the present invention according to one embodiment.

References in the detailed descriptions below correspond to like references in the figures unless otherwise noted.

### DETAILED DESCRIPTIONS OF THE PREFERRED EMBODIMENTS

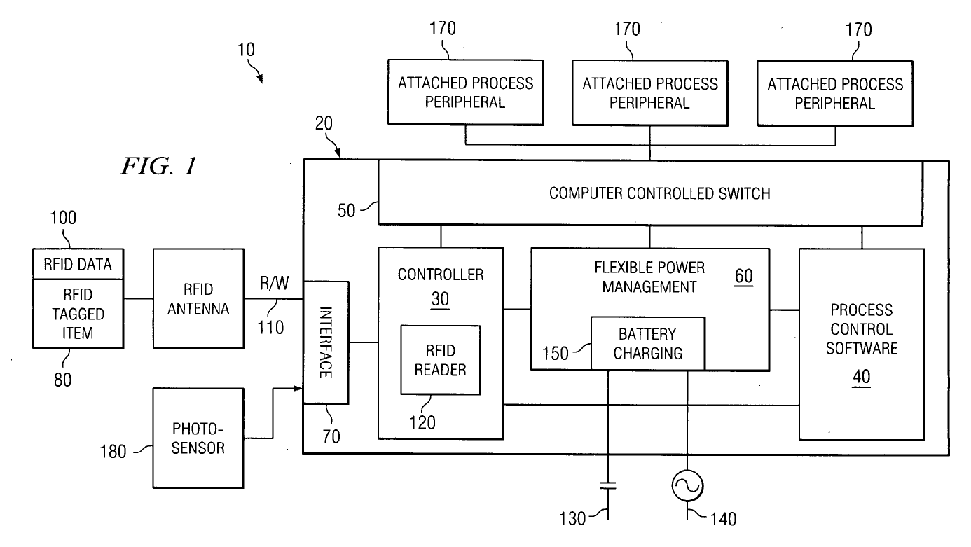

Referring now to the Figures and specifically to FIG. 1, a block diagram of an Radio Frequency Identification (RFID) process control system according to the invention is shown and denoted generally as 10. RFID process control system 10 is adapted for use as part of a complete RFID inventory tracking process according to the invention. As shown, RFID process control system 10 includes an enclosure 20 which houses the various components of the system 10 including RFID controller 30, process control software 40 and computer controlled switch 50. Also, a flexible power management subsystem 60 is provided within the enclosure 20 of the RFID process control system 10.

Enclosure 20 also includes an interface 70 which provides the communication path between the components within enclosure 20 of the RFID process control system 10 and external devices such as RFID tagged item 80. As shown, an RFID antenna 90 may be optionally used to assist in the transmission of RFID data 100 from/to the enclosure 20 and specifically to the RFID controller 30 within the enclosure 20. As shown, a communications pathway 110 between the RFID tagged item 80 and interface 70 of the enclosure 20 provides a way to read RFID data 100 contained on RFID tagged item 80. In addition, RFID data 100 can be written by RFID controller 30 to update the information contained in the RFID data 100. The fact that RFID controller 30 can write and/or update the information contained on RFID tagged item 80 provides a substantial advantage as updated history tracking information for the RFID tagged item 80 can be provided giving the end customer or handler of RFID tagged item 80 some information about the whereabouts of the RFID tagged item 80.

As shown, RFID controller 30 includes a RFID reader 120 of the type well known to those of ordinary skill in the art. For example, RFID reader 120 can be any of various commercially available RFID readers or reader modules such as those provided by Intermec, Alien Technology, Texas Instruments, Matrics and other similar products as are provided by a host of RFID reader and/or reader module manufacturers. Therefore, it is contemplated that the architecture of the RFID reader 120 is flexible and open enough to permit integration of a readily available RFID reader 120 to permit a RFID process control system 10 according to the invention.

RFID process control system 10 includes a power management subsystem 60 which as indicated is flexible enough to accommodate a variety of power requirements depending on the needs of the various components within enclosure 20. For example, depending on the environment and specific components used to implement RFID process control system 10, some of components may require AC (alternating current) power while other components may require DC (direct current). Likewise, one RFID reader may operate using an AC voltage in places where you only have DC power or vice versa. Therefore, power management subsystem 60 provides a way of converting once source of power to another and, as such, acts as a single source of power for all of the components within enclosure 20 including the RFID reader 120, controller 30, computer controlled switch 50 and the other devices. Also, external inputs 130 and 140 couple a DC input and an AC input, respectively, to a battery charging circuit 150 which allows power management subsystem 60 to provide both DC and AC power as well as varying levels of DC and AC power. In addition, since power can be stored in a battery (not shown but well known and understood) by battery charging circuit 150, once charged the RFID process control system 10 can operate unplugged for a period of time. Also, by being flexible, power management subsystem 60 can provide power to different types of readily available RFID readers 120 such as, for example, and Intermec reader which may require 9 volts or an Alien reader which may require 5 volts. Power management subsystem 60 has the ability to power either of them. In this way, RFID process control system 10 can be used in a wide array of environments.

Attached to enclosure 20 are a variety of peripherals 170 which interface to computer controlled switch 50 and which allow the RFID process control system 10 to take action based on the content of RFID data 100 received from an RFID tagged device 80 via interface 70. For example, the RFID tagged item 80 can be read to indicate that a certain order has been received. If the RFID event involves notifying the end user when a specific RFID tagged device 80 has arrived, once the RFID data 100 is read and confirmed by process control software 40, the the RFID controller 30 can cause the computer controlled switch 50 to operate an attached peripheral 170 that would inform the user of the arrival. While the peripheral can take numerous forms, it can also be something as simple as a light (colored light, for example) that indicates an item has arrived that matches the customer's purchase order.

Another example would be a truck driving up to the gate with an RFID tagged item 80. The item 80 can be processed by the process control software 40 and a determination can be made that indicates the truck is delivering an expected order and thereby causes the gate to open allowing the truck to enter the premises. If the next guy is not expected, a guard can be alerted via the attached peripherals 170 and the gate is not opened. To facilitate such a process, a photosensor 180 can be utilized to provide additional data input to the controller 30.

Accordingly, the process logic within the process control software 40 allows the implementation of countless inventory process control tasks. By integrating process control software 40 within the same enclosure containing the reader 120, controller 30 and computer controlled switch 50, total process control is achieved at the Point of Action (POA), i.e. where the RFID data is read or expected to be read as opposed to some other point distant from the reader or downstream from the reading function. As such, complete process control with flexible functionality limited only by the process software 40 and the attached peripheral 170 is achieved.

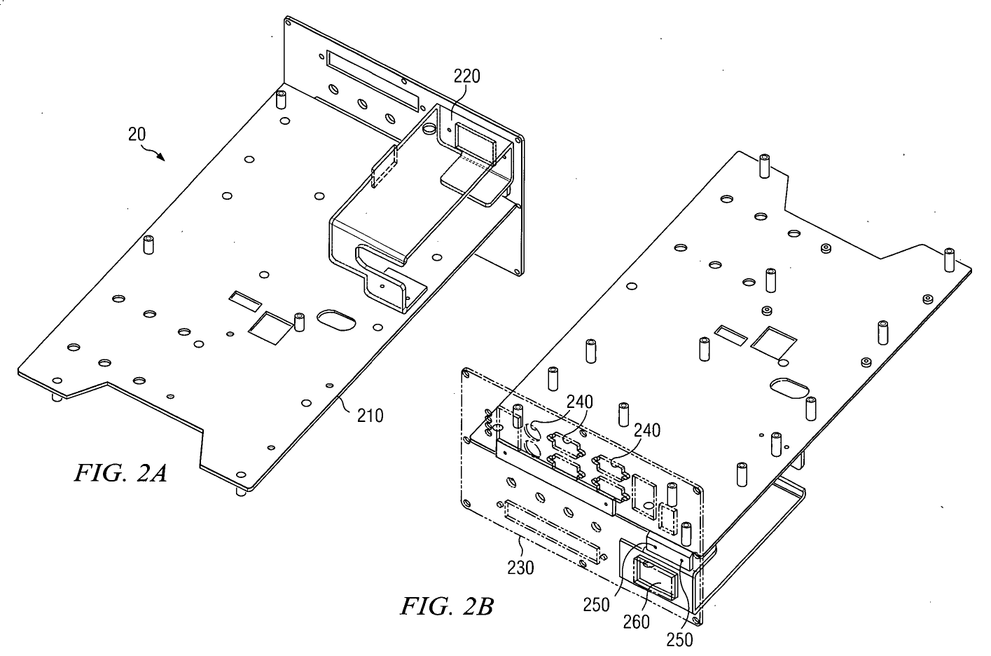

FIGS. 2-7 show the mechanical details of one exemplary embodiment for an enclosure 20 according to the invention. It should be understood that the present invention encompasses many configurations of an enclosure which would provide a housing for the various components of a RFID process control system, such as system 10, according to the invention.

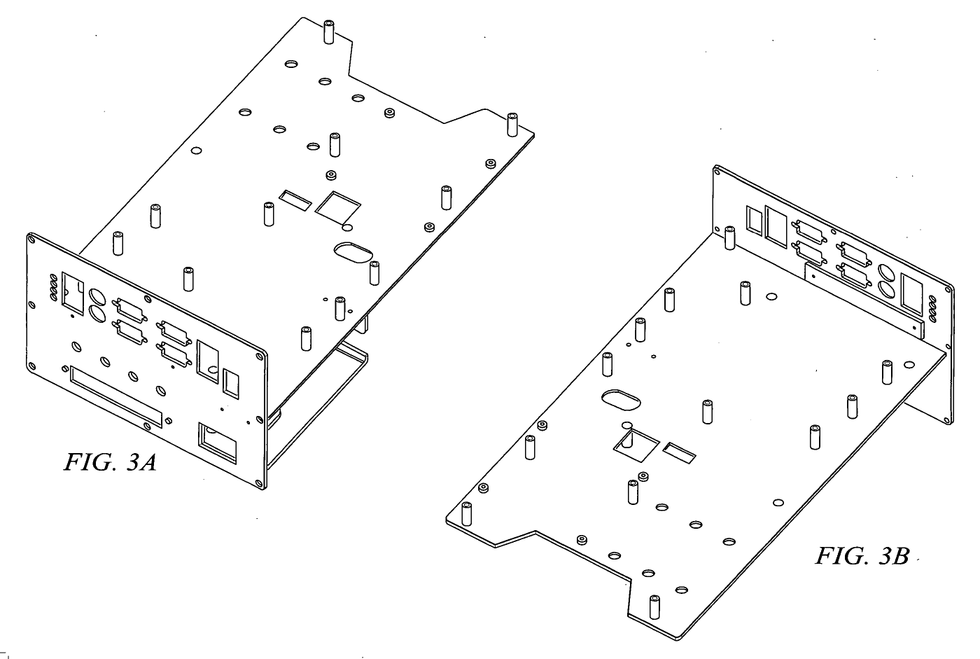

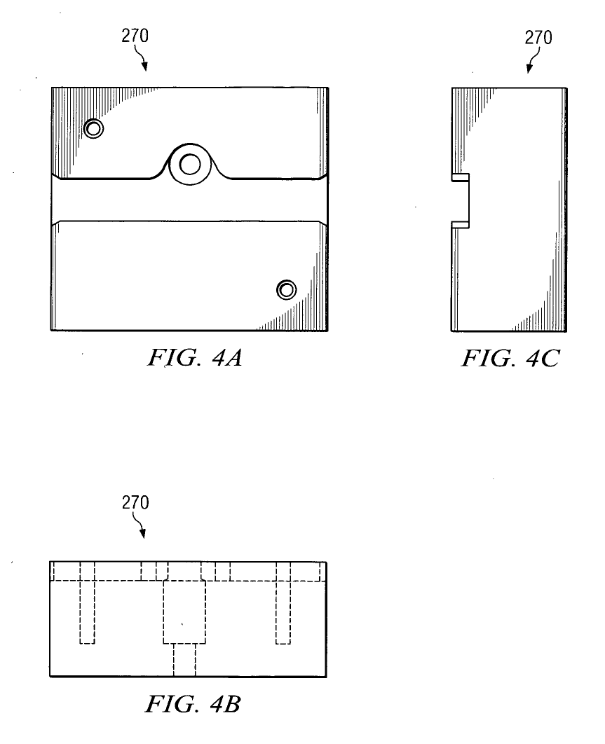

As shown, enclosure 20 includes a plate 210 which supports a power supply housing 220 in which the power management subsystem 60 can be maintained. The faceplate 230 provides support for the various input/output (I/O) ports 240 which form the interface 70 of the enclosure 20. A power switch 250 can be used to turn power ON and OFF to the system 10 with external power connector opening providing a place for an external power source (not shown) to be connected. Other perspectives of an enclosure 20 suitable for use in an RFID process control system 20 are illustrated in FIG. 3. It is assumed that the mechanical details represented by FIGS. 2 and 4 would be well understood by those of ordinary skill in the art.

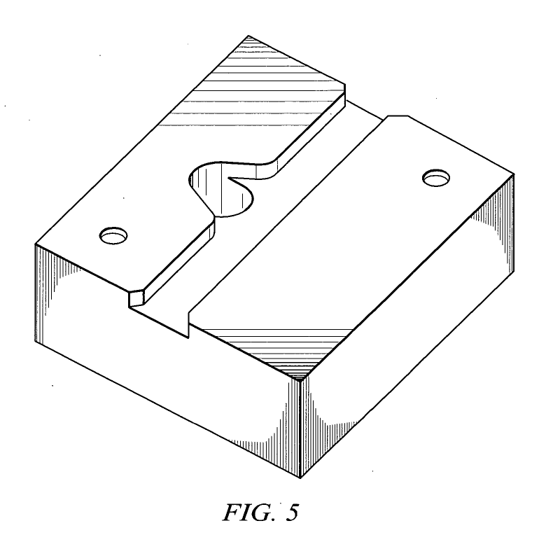

FIGS. 4 and 5 illustrate the mechanical details of a suitable and exemplary heat sink 270 which can be used to dissipate the heat generated by the various components of an enclosure, such as enclosure 20. Again, the illustrations are provided solely for the purpose of eliminating any undue experimentation and it is assumed that the mechanical details would be well understood by and within the grasp of those of ordinary skill in the art. Furthermore, it is contemplated that other configurations of many of the devices illustrated will and can be utilized.

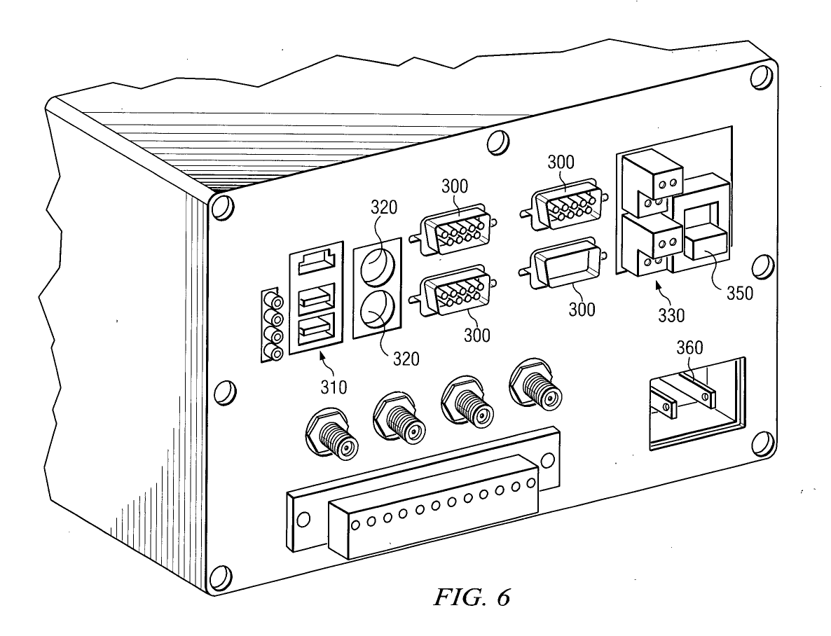

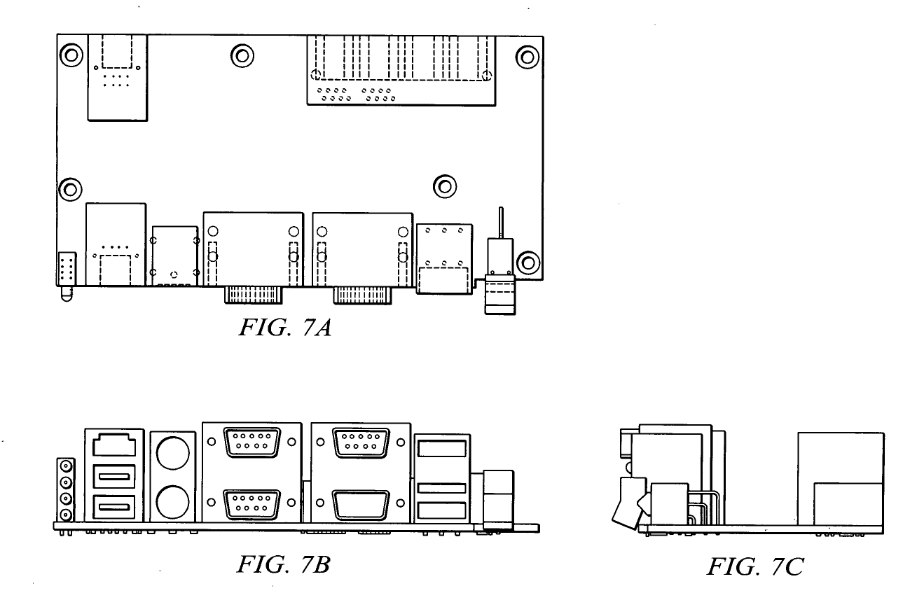

FIGS. 6 and 7 illustrate the various ports and dimensions thereof which an enclosure, such as enclosure 20, can utilize according to one exemplary embodiment and in order to provide a wide array of I/O options to a RFID process control system according to the invention. As shown, the interface 70 can include one or more serial ports 300, universal serial bus (USB) ports 310, PS-2 ports 320 as well as a DC power interface 330. A power switch 350 is also provided along with power adapter 360. As such, the enclosure 20 provides a housing for a variety of RFID functional components, power components and interface options that provide a self-contained and highly versatile RFID process control system.

The present invention also provides a method of using a RFID process control system, such as system 10, to process items tagged with RFID data. With reference to FIG. 8, therein is shown a flow diagram for a process, denoted generally as 400, illustrating the method of the present invention according to one embodiment. Process 400 begins at step 410 wherein a RFID controller 30 of system 10 reads RFID data 100 from at least one RFID tagged item 80 passing a designated POA. Next, at step 420 the RFID controller 30 passes the RFID data 100 to process control software 40 of system 10. At this point, it is determined if the RFID tagged item 80 satisfies a specified RFID event, step 430. This is achieved, for example, by the process control logic contained in software 40 interpreting the RFID data 100 received by the RFID controller 30 via the interface 70. If the desired RFID event has not occurred, as determined at step 430, then process flow is directed to step 440 wherein the system 10 waits for the next RFID tagged item.

If the desired RFID event has occurred, as determined by the process control software at step 430, then process flow is directed to step 450 wherein computer controlled switch 50 activated the appropriate peripheral 170, step 460. At this point, the controller 30 can wait for the next tagged item at step 440 or, alternatively, the RFID controller 30 may write to the RFID tagged item 80. This may comprise writing data that reflects the history of the RFID tagged item 80.

While the invention has been described in connection with various preferred embodiments, the descriptions should not be interpreted in a way that limits the scope of the following claims in the context of the true spirit and nature of the inventive concepts described herein. In particular, it is anticipated that various modifications and variations will become apparent to those of ordinary skill in the art upon reference to the descriptions contained herein and it is intended that such modifications and variations should be interpreted as within the scope of the following claims.

Also, it should be understood that the many of the components described herein can take the form of hardware or software as the technology permits using readily available components and techniques. For example, much of what is contained within the enclosure 20 of the system 10 can be implemented using readily available computing parts such as, for example, a standard Personal Computer (PC) with appropriate software. Other variations will become apparent upon reference to this disclosure taken in connection with the knowledge of those of ordinary skill in the art.

1. A Radio Frequency Identification (RFID) process control system comprising:
an interface supporting communications with a plurality of industry standard compliant devices:
an RFID controller for communicating RFID data over the interface, said RFID controller including at least one RFID reader for reading said RFID data from an RFID tagged item;
process control software for detecting the occurrence of a specified event represented by the RFID data; and
at least one computer controlled switch operably coupled to the RFID controller;
wherein a specified RFID event can be determined from the RFID data received by the RFID controller via the interface as interpreted by the process control software and thereby cause the RFID controller to operate the computer controlled switch to control a desired process.

2. The RFID process control system of claim 1 further comprising an enclosure housing the interface, RFID controller, process control software and computer controlled switch.

3. The RFID process control system of claim 1 wherein communications between the RFID tagged item and the RFID controller over the interface are bidirectional.

4. The RFID process control system of claim 3 wherein the RFID controller can write data to the RFID tagged item over the interface.

5. The RFID process control system of claim 1 wherein the interface is a wired interface providing a physical communications path between the RFID and the RFID tagged item.

6. The RFID process control system of claim 1 wherein the interface between the RFID and the RFID tagged item is wireless.

7. The RFID process control system of claim 1 further comprising at least one peripheral coupled to said computer controlled switch.

8. The RFID process control system of claim 7 wherein said peripheral comprises a light that is operated by the computer controlled switch in response to specified RFID data from a RFID tagged item being read by said RFID controller.

9. The RFID process control system of claim 1 further comprising a power management subsystem for providing power to the RFID controller, the computer controlled switch and the process control software.

10. The RFID process control system of claim 9 wherein the power management subsystem can provide both DC and AC power.

11. The RFID process control system of claim 9 wherein the power management subsystem can provide variable levels of both DC and AC power.

12. The RFID process control system of claim 9 wherein the power management subsystem further comprises a battery charging circuit.

13. The RFID process control system of claim 1 wherein the RFID controller further comprises any one of several industry standard RFID readers.

14. The RFID process control system of claim 13 wherein the RFID controller can sense the interface requirements of the specific industry standard RFID reader within the enclosure.

15. The RFID process control system of claim 1 wherein said interface supports communications with a photo-sensor device.

16. A Radio Frequency Identification (RFID) process control system comprising:
an interface supporting communications with a plurality of industry standard compliant devices including at least one RFID tagged item:
an RFID controller for communicating RFID data with said RFID tagged item over the interface;
process control software for detecting the occurrence of a specified event represented by the RFID data;
at least one computer controlled switched operably coupled to the RFID controller; and
an enclosure housing the interface, RFID controller, process control software and computer controlled switch;
wherein a specified RFID event can be determined from the RFID data received by the RFID controller via the interface as interpreted by the process control software and thereby cause the RFID controller to operate the computer controlled switch to control a desired process.

17. The RFID process control system of claim 16 wherein said enclosure is an FCC approved computer-style enclosure.

18. The RFID process control system of claim 16 wherein said interface comprises at least one physical interface chosen from the group consisting of: a parallel port, a serial port, a universal serial bus, a PS-2 port.

19. The RFID process control system of claim 16 further comprising a power management subsystem within the enclosure and operably coupled to components requiring power.

20. The RFID process control system of claim 19 wherein wherein the power management subsystem can provide both DC and AC power.

21. The RFID process control system of claim 19 wherein the power management subsystem can provide variable levels of both DC and AC power.

22. The RFID process control system of claim 16 wherein communications between the RFID tagged item and the RFID controller over the interface are bidirectional.

23. The RFID process control system of claim 16 wherein the RFID controller can write data to the RFID tagged item over the interface.

24. The RFID process control system of claim 16 wherein the interface is a wired interface providing a physical communications path between the RFID and the RFID tagged item.

25. The RFID process control system of claim 16 wherein the interface between the RFID and the RFID tagged item is wireless.

26. The RFID process control system of claim 16 further comprising at least one peripheral coupled to said computer controlled switch.

27. The RFID process control system of claim 16 further comprising an RFID antenna interspersed between the RFID tagged item and the RFID controller for delivering the RFID data to the system.

28. Using an integrated Radio Frequency Identification (RFID) process control system, a method of processing items tagged with RFID data comprising the steps of:
a RFID controller within the system reading RFID data from at least one RFID tagged item;
the RFID controller passing the RFID data to process control software within the system; and
determining if the RFID tagged item satisfies a specified RFID event by the process control software interpreting the RFID data received by the RFID controller via the interface and thereby control of a desired process.

29. The method of claim 28 further comprising the step of the RFID controller causing a computer controlled switch within the system to operate an attached peripheral when a specified RFID event has been detected.

30. The method of claim 28 further comprising the step of the RFID controller writing data to the RFID tagged item.

31. The method of claim 30 wherein the step of the RFID controller writing data to the RFID tagged item comprises writing data reflecting this history of the RFID tagged item.
